(19) United States
(12) Patent Application Publication
(10) Pub. No.: US 2015/0194044 A1
(43) Pub. Date: Jul. 9, 2015

(54) MOBILE, LOCATION-AWARE, SELF-POWERED ALARM AND SIGNAL PROCESSING SYSTEM

(71) Applicant: Seagate Alarm & Signal, Milbury, OH (US)

(72) Inventors: James M. Adams, Swanton, OH (US); David Feltner, Sylvania, OH (US); David Levison, Whitehouse, OH (US)

(21) Appl. No.: 14/591,992

(22) Filed: Jan. 8, 2015

Related U.S. Application Data
(60) Provisional application No. 61/924,794, filed on Jan. 8, 2014.

(51) Int. Cl. G08B 25/01; G08B 25/10

(52) U.S. Cl. CPC G08B 25/016; G08B 25/10

(57) ABSTRACT

A mobile, location-aware, self-powered alarm system is disclosed. The alarm system is powered by a combination of a battery and a solar panel and provides communication between a remote module and law enforcement and a data center. The alarm system is adapted to trigger an alarm to notify the remote module, which can include a central operator, of a theft or attempted theft according to desired parameters so that the local law enforcement can be notified.

### CROSS-REFERENCE TO RELATED APPLICATIONS

This application claims the benefit of U.S. Provisional Application No. 61/924,794, filed on Jan. 8, 2014. The entire disclosure of the above application is incorporated herein by reference.

### FIELD

The invention relates to an alarm system, and more particularly to a mobile, location-aware, self-powered alarm and signal processing system.

### INTRODUCTION

This section provides background information related to the present disclosure which is not necessarily prior art.

Construction companies utilize large equipment, such as bulldozers and excavators, and storage trailers to house tools and equipment while workers are engaged on a job site. Many trailers can be in use at any one time across a region that the construction company services. The large equipment and trailers typically remain on the job site for the duration of the contract, which can stretch for weeks, months, or even years. Oftentimes during the construction project, the equipment and trailers are left unattended, such as at night, during weekends, and during holidays. Theft of or from the large equipment and/or storage trailers can cause the construction company to incur substantial costs and insurance claims to replace the stolen equipment. Likewise, time is lost in replacing the equipment and in completing the construction project. Cost to replace the stolen equipment and increased insurance premiums can be subsequently passed on the customers, thereby driving up construction costs.

Problems arise with existing alarm system technology in that less than optimal protection means are available to users. An immediate response can help ensure retrieval of an asset. Additionally, it is important to maintain power for the alarm system located at the equipment or trailer. It is further desirable that the alarm system or protection means should be easily accessed and controlled from any location.

Information relevant to attempts to address these problems can be found in U.S. Pat. Nos. 5,563,453; 5,682,133; 6,028,537; 6,542,076; 6,687,609; 6,983,202; and U.S. Pat. App. Pub. No. 2005/0248444. However, the systems or devices of each of these documents suffers from one or more of the following disadvantages: (1) ease of circumvention; (2) lack of a self-contained power source; (3) lack of an immediate response to the acts of a thief; and (4) the inability to be accessed and controlled from any location.

U.S. Pat. No. 7,834,757 to Rodgers et al. attempts to address the deficiencies of the foregoing patent documents. However, the '757 patent does not disclose a system or device in communication with a central monitoring service or the use of a GPS system by the central monitoring service to contact a local law enforcement organization in the event that the asset is moved without authorization or moved outside of a desired area.

Thus, it would be desirable to develop a mobile, location-aware, self-powered alarm and signal processing system that can be remotely monitored and capable of contacting local emergency services.

### SUMMARY

The present technology includes alarm systems and methods of operating alarm systems.

Alarm systems include a global positioning system (GPS) module, a wireless communication module, an independent power module, and a remote module. The GPS module is configured to provide a location signal using GPS satellite signals. The wireless communication module is configured to send a wireless signal, the wireless signal including the location signal. The independent power module is configured to provide electrical power to the GPS module and the wireless communication module. The remote module is configured to receive one of the wireless signal and a retransmission of the wireless signal, where the remote module is configured to contact an emergency service dependent on the location signal. One of the wireless communication module and the remote module can be configured to trigger an alarm when the location signal does not match a parameter, the alarm instructing the remote module to contact the emergency service dependent on the location signal. The parameter can include one of GPS coordinates and an area defined by GPS coordinates. The wireless communication module can be configured to communicate with a cellular network. The wireless communication module can be configured to receive a wireless signal and the remote module can be configured to send one of a wireless signal and a signal that is retransmitted into a wireless signal. The independent power module can include a battery and can be configured to generate electrical power using a solar panel.

The alarm system can be operated by sending the wireless signal using the wireless communication module. One of the wireless signal and a retransmission of the wireless signal is received using the remote module. Where one of the wireless communication module and the remote module is configured to trigger an alarm when the location signal does not match a parameter, the alarm instructing the remote module to contact the emergency service dependent on the location signal, the location signal can be compared with the parameter and the alarm triggered when the location signal does not match the parameter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an alarm system according to an embodiment of the present technology; and

FIG. 2 is a diagram showing additional communication aspects of the alarm system of FIG. 1.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments. Except in the examples, or where otherwise expressly indicated, all numerical quantities in this description indicating amounts of material or conditions of reaction and/or use are to be understood as modified by the word “about” in describing the broadest scope of the technology.

The present technology relates to an alarm system configured as a mobile, location-aware, and self-powered alarm and signal processing system and includes various ways of operating such a system. The alarm system can be primarily used in the construction industry to protect valuable job site assets, including equipment, materials, and tools stored in mobile trailers. However, the alarm system can be installed in non-mobile applications that require protection from theft and vandalism, such as tool sheds, barns, farm machinery, and outbuildings, for example. In addition, the alarm system can be helpful in certain non-commercial mobile applications where asset protection is needed. For example, the alarm system can be used with respect to motor homes, recreational vehicles, clocked boats, and virtually any other high value asset protection application where direct connection to an electrical grid and/or communication line is not practical.

The alarm system can use a wireless network, such as a wireless interne network or a cellular network. Accordingly, no phone lines need to be wired for remote communications. The system can be available in a highly ruggedized outdoor rated, powder coated or painted steel enclosure, and can be designed and constructed with components rated for extreme cold and hot temperatures that can be encountered during the summer and winter. A user interface including a keypad and backlit LCD display for accessing all functions and settings can be disposed on an exterior thereof. The enclosure can house the main printed circuit board, cellular modem/GPS device, charge controller, batteries, external door mounted keypad and display and wiring to external devices and sensors. The enclosure can ventilated to prevent humidity buildup. A piano hinged door, keypad and display can be sealed to resist water and chemical entry into the enclosure. Opening the enclosure can require a special tool and an integrated door switch to ensure a tamper proof system that can trigger an alarm condition and send out a remote signal when the door is opened before any internal damage or sabotage can even begin.

An independent power module, such as a solar panel and battery, can also part of the alarm system. The solar panel can serve to power the system and to charge one or more batteries disposed within one or more alarm system enclosures. The solar panel can be in communication with a solar controller. The solar controller controls the charging of the batteries from the included solar panel and ensures that the batteries are kept charged, but not overcharged, which can lead to reduced life and potential leakage. At night or during times of low light levels, the batteries can power the system. Because energy usage of the alarm system is minimized, the alarm system can run for extended periods of time (e.g., up to two weeks) on the included batteries without any external charge source. Because the alarm system includes a battery and solar power charging capabilities, no external power source is needed and the system can be easily moved or transferred from one trailer, building, or device to another.

In certain embodiments, the alarm system can include connections for use with a variety of input sensors such as motion sensors and door/window contacts. The system can include one motion sensor and can have inputs for different types of dry contact sensors and can be capable of zoning. The alarm system can be compatible with UL listed and industry standard Central Station Monitoring services for 24 hour continuous protection and response from local law enforcement agencies. It can also include a high-decibel siren and can include a high-brightness outdoor strobe light for easy location in dark environments or high address density and equipment-dense areas. The siren can be mounted in a second enclosure mounted above the main enclosure. A flexible armored conduit connecting the two enclosures can be used to house the wiring between the main enclosure and the siren enclosure as well as to protect the wiring to a roof mounted combination cellular/GPS antenna and solar panel. It is understood that the siren can be enclosed within the first housing, as desired. The alarm system can be adapted to communicate with a UL listed Central Station and can be configured to send alerts to a job site supervisor or end user's cellular phone via SMS text, email, automated phone message, or the like. The alarm system can communicate via a wireless communication device.

In some embodiments, the alarm system is able to communicate directly with construction equipment monitoring devices for purposes of communicating job site machine performance parameters. To facilitate such applications, the alarm system can be capable of processing other types of input signals and generating alerts for many commercial applications, such as temperature monitoring of concrete pours via thermocouples and the like, remote wireless panic buttons for people traveling in motor homes, etc. Other examples include monitoring of oil levels, engine temperatures, humidity, moisture content, ambient conditions (temperature, pressure, humidity), pressures with vessels or parts of equipment, and other critical machine maintenance parameters so equipment managers can remotely check on potential breakdowns and schedule service before a breakdown occurs.

In various embodiments, the alarm system can remotely and automatically communicate with a data center that stores complete histories for each system and for a variety of different event types, such as arming, disarming, low battery condition, door tampering, and the like. The alarm system can communicate with the data center via a cellular connection, a wireless connection, communication with a satellite, or any other means of data uploading, downloading, or sharing. The data center web portal can be a user friendly management interface where end users of the alarm system can view the system status (armed/disarmed, etc.) and keep track of whose passwords are being used to arm and disarm the system as well as view all of their systems on a map, and remotely arm/disarm them. It is understood that the data center can be a hard drive or other memory device that is disposed within the enclosure. The data center can be removable, as desired, or the data center can include means for downloading information therefrom, such as USB ports, serial ports, and the like. This portal can also allow end users to manage passwords and account access for their job site employees. In certain embodiments, a cellular phone or other smart phone can be loaded with an application that can serve as the web portal. The alarm system can be armed and disarmed remotely via a mobile phone using a simple SMS text message with proper password credentials. This is useful in the case where someone has left the job site and did not arm the system.

The alarm system can be distinguished from other alarm systems that are installed in homes and commercial buildings as follows: the alarm system is mobile, self-contained, battery operated and solar charged, wireless cellular system with onboard GPS hardware. When a device or equipment having the alarm system is moved, the end user is not required to notify a monitoring service. The alarm system can be self-aware and transmit its GPS coordinates with each alarm signal automatically when the system is moved from a desired location.

Transmitted GPS coordinates can be reverse geocoded in real time at a central station and can be used to query a public service answering point emergency database. Receipt of the reverse geocoded coordinates can allow the central station operator to determine the location of the device or equipment having the alarm system. Based on the location of the device or equipment, the appropriate local law enforcement agency (based on the coordinates and location of the device or equipment) can be contacted to take the appropriate action such as dispatch the appropriate law enforcement and to provide notification to the end user. Based on the GPS coordinates, software loaded on a computer at the central station or on a processor in the alarm system can resolve the phone number(s) of the emergency responder(s) in the jurisdiction where the equipment or device is located. By immediately determining the appropriate jurisdiction of law enforcement, a time to protect and/or recover to the alarm system and/or equipment or can be minimized. Furthermore, if the device or equipment is being moved and crosses into a different jurisdiction, the central operator can notify law enforcement in numerous jurisdictions or place the different law enforcement personnel in communication to apprehend the thief and recover the asset.

The alarm system can have geofence capabilities. For example, the alarm system can send an alarm signal or alert to the central station operator if the alarm system (and corresponding equipment or device) is moved outside of an adjustable geographical boundary, indicating a mobile theft in progress which can be tracked. The geographical boundary can be set to coordinates of the job site, or within a few hundred feet or a few thousand feet of a job site, or within a radius of a few miles, as desired.

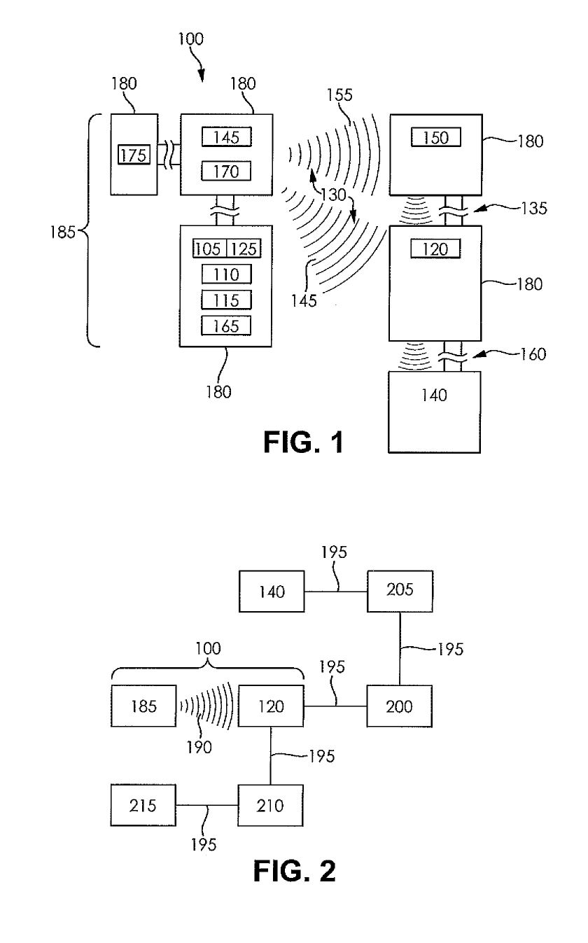

With reference now to FIG. 1, an embodiment of an alarm system 100 according to the present technology is diagrammatically shown. The alarm system 100 includes a global positioning system (GPS) module 105, a wireless communication module 110, an independent power module 115, and a remote module 120. The GPS module 105 is configured to provide a location signal 125 using GPS satellite signals. The wireless communication module 110 is configured to send a wireless signal 130 that includes the location signal 125. The independent power module 115 is configured to provide electrical power to the GPS module 105 and the wireless communication module 110. The remote module 120 is configured to receive one of the wireless signal 130 and a retransmission 135 of the wireless signal 130. The remote module 120 is configured to contact an emergency service 140 dependent on the location signal 125.

The GPS module 105 can determine GPS coordinates and can determine areas defined by GPS coordinates by receiving signals from GPS satellites. The GPS module 105 can employ a plurality of channels using a plurality of GPS satellite signals to determine the location signal 125. The location signal 125 can include latitude and longitude values and can include an elevation value. In this way, the location signal 125 can identify a three-dimensional position. The GPS module 105 can be just one of multiple GPS modules 105, where various GPS modules 105 are associated with various assets across a job site. For example, GPS modules 105 can be affixed to various vehicles, pieces of equipment, trailers, buildings, etc. so that multiple location signals 125 can be used to define coordinates and areas for each GPS module 105. In this way, for example, the location signal 125 for a GPS module 105 affixed to a vehicle can define an area where the vehicle is permitted to operate, whereas another GPS module 105 can be affixed to a stationary tool shed that defines a location signal 125 having particular set of GPS coordinates.

The wireless communication module 110 is configured to send the wireless signal 130 that includes the location signal 125 from the GPS module 105. The wireless communication module 110 can be connected to an antenna module 145, where the connection is either hardwired or wireless, the antenna module 145 configured to send the wireless signal 130. The wireless communication module 110 can be configured to communicate with various wireless networks, including a cellular network such as employed by various cellular telephone and/or data carriers. The wireless communication module 110 can also be configured to receive a wireless signal, optionally employing the antenna module 145. For example, the remote module 120 or another device can be configured to send one of a wireless signal and a signal that is retransmitted into a wireless signal to the wireless communication module 110.

The independent power module 115 provides an independent source of electrical power to the alarm system 100, where it is not necessary to connect the alarm system or portions of the alarm system to an electrical grid. In certain embodiments, the alarm system can be connected to an electrical grid, depending on the location of the job site. However, in such applications, the independent power module 115 can maintain electrical power to the alarm system 100 in the event of a power failure or interruption of the electrical grid. The independent power module 115 can include one or more batteries, including various types of batteries. Such batteries can be rechargeable or replaceable and can be configured to allow the independent power module 115 to provide electrical power to the GPS module 105 and the wireless communication module 110 for hours, days, weeks, or more. The independent power module 115 can also be used to provide electrical power to other components of the alarm system 100, such as providing electrical power to boost the antenna module 145. The independent power module 115 can also be configured to generate electrical power that is directly provided to the alarm system 100 or to charge one or more batteries. Electrical power can be generated using various off the grid means, including one or more solar panels, wind turbines, hydroelectric generators, internal combustion engines, and combinations thereof. In some embodiments, for example, the independent power module 115 includes a battery and is configured to generate electrical power using a solar panel.

The remote module 120 receives one of the wireless signal 130 and a retransmission 135 of the wireless signal 130 from the wireless communication module 110. For example, the remote module 120 can directly receive the wireless signal 130, as shown at 145, and/or the remote module 120 can indirectly receive the wireless signal 130 through a transceiver module 150. The transceiver module 150 can receive the wireless signal 130, as shown at 155, and retransmit the wireless signal 130 using the retransmission 135 that is directly connected to the remote module 120 and/or wirelessly connected to the remote module 120. The remote module 120 can be configured to record information contained in the one of the wireless signal 130 and the retransmission 135 of the wireless signal 130. For example, the remote module 120 can continuously or intermittently log various aspects of the alarm system 100, including arming status, password use, password management, or password change, alarm activation or deactivation, values related to one or more location signals 125 from one or more GPS modules 105, etc.

One of the wireless communication module 110 and the remote module 120 can be configured to trigger an alarm when one or more of the location signals 125 does not match a parameter, where the alarm instructs the remote module 120 to contact the emergency service 140 dependent on the location signal 125. For example, the parameter can include one of GPS coordinates and an area defined by GPS coordinates. In this way, the remote module 120 can directly or wirelessly contact the emergency service 140, as shown at 160, dependent on the location signal 125. The appropriate emergency service for the municipality or jurisdiction corresponding to the location signal 125 can be contacted and/or the emergency service most proximate to the location signal 125 can be contacted. The emergency service 140 can include one or more of law enforcement, private security, a fire department, and a medical service such as an ambulance. For example, where the alarm is associated with theft, such as a location signal 125 indicating an asset has moved from certain GPS coordinates or outside an area defined by GPS coordinates, the emergency service 140 can include law enforcement or private security. Other aspects of the alarm system 100 can include fire detection or request for medical attention, where a fire department or a medical service local to the location signal 125 is contacted.

The wireless communication module 110 can be configured to receive a wireless communication and the remote module 120 can be configured to send an instruction to the wireless communication module 110. The instruction can include operational aspects of the alarm system 100, including arming, disarming, a password, a password change, alarm activation, alarm deactivation, etc. The wireless communication module 110 and/or the remote module 110 can further communicate with other devices, including cellular phones, computers, or various applications that can be run on mobile devices, portable computers, smart phones, etc. For example, a user can operate aspects of the alarm system 100 using a smart phone, where the smart phone contacts the remote module 120 which contacts the wireless communication module 110. Alternatively, the smart phone can directly contact the wireless communication module 110.

In some embodiments, the alarm system 100 can further include an interface module 165 that is configured to receive an input and provide an output for the alarm system 100. The interface module 165 can allow a user to operate the alarm system 100 and change various settings, instructions, or parameters of the alarm system, such as arming/disarming, defining one or more alarms based on one or more location signals 125, entering and changing one or more passwords, and activating/deactivating various modules, components, or accessories of the alarm system 100. The interface module 165 can include a keypad for receiving input and can include a display for providing output. Alternatively, the interface module 165 can include a touchscreen that can receive input and display output.

In various embodiments, the alarm system 100 can further include at least one alarm indicator module 170 that can indicate an alarm is triggered. The alarm indicator module 170 can include various audible and visual indicators, such as a siren, a light, and/or a strobe. The alarm indicator module 170 can be directly connected to other modules of the alarm system 100 and can also be wirelessly connected to other modules. For example, the wireless communication module 110 and/or the remote module 120 can trigger an alarm when one or more of the location signals 125 does not match a parameter. The alarm can instruct the remote module 120 to contact the emergency service 140 dependent on the location signal 125 and can activate the alarm indicator module 170 to provide an audible and/or visual alarm, such as a siren and strobe. Use of audible and/or visual alarm can deter further activity by a thief and can facilitate identification and location of an asset protected by the alarm system 100 upon arrival of the emergency service 140.

In certain embodiments, the alarm system 100 can further include one or more sensor modules 175 that are in direct or wireless communication with the wireless communication module 110. The wireless signal 130 can include a signal from the sensor module 175. In this way, the remote module 120 can monitor the status of the sensor module 175 and can activate an alarm, including activation of the alarm indicator module 170. The sensor module can also be configured to directly activate the alarm indicator module 170. Various examples of the sensor module 175 include a motion sensor, a door contact, a window contact, a sound sensor, a temperature sensor, and a smoke detector. Various sensor modules 175 can be positioned around a job site and affixed to various assets, as appropriate for their intended function. For example, a door to an equipment trailer can be monitored by a door sensor, windows to a mobile office can be monitored by window sensors, and the interior of the mobile office can be monitored by a smoke detector and a motion sensor.

The various modules of the alarm system 100 can be provided independently or in various combinations within various enclosures 180. The enclosure(s) can be weather resistant and shock resistant. This allows the alarm system 100 to be employed at job sites experiencing various weather conditions, including rain, wind, snow, and subfreezing conditions. The shock resistant nature of the enclosure(s) can mitigate tampering or damage to the alarm system 100. In some embodiments, the enclosure 180 can include a sensor module 175 that can activate an alarm, for example, if the enclosure 180 is tampered with, opened without authorization, or damaged.

Turning now to FIG. 2, a schematic of lines of communication between the alarm system 100 and other devices and entities is shown. The alarm system 100 is shown divided into the various modules located at the job site 185 and the remote module 120. For example, as shown in FIG. 1, the modules located at the job site 185 can include the GPS module, 105, the wireless communication module 110, the independent power module 115, the antenna module 145, the interface module 165, the alarm indicator module 170, and the sensor module 175. Lines of communication shown as waves 190 indicate wireless communication and lines of communication shown as solid lines 195 indicate directly connected and/or wireless communication. It should be noted that the remote module 120 can also be located at or near the job site, but the remote module 120 receives one of the wireless signal 130 and a retransmission 135 of the wireless signal 130 from the wireless communication module 110. As shown in FIG. 1, the remote module 120 can directly receive the wireless signal 130, as shown at 145, and/or the remote module 120 can indirectly receive the wireless signal 130 through the transceiver module 150.

The remote module 120 can communicate with a public service answering point (PSAP) emergency database 200. The PSAP emergency database 200 can provide information regarding the alarm system 100, including the location of the alarm system 100 based on the location signal 125, where the location can include an address, map, and listing of local emergency services 140. The remote module 120 can also communicate other information to the PSAP emergency database 200, including the status of alarms provided by various sensor modules 175. The information from the PSAP emergency database 200 can be communicated to a central station operator 205 that can dispatch the appropriate emergency service 140, including law enforcement, private security, a fire department, and/or a medical service that is local and dependent on the location signal 125.

The remote module 120 also can communicate with a data center 210. The data center 210 can log events, operations, and various information from the alarm system 100 and can communicate with multiple alarm systems 100. The data center 210 can communicate with a remote communication device 215 that allows a user to access the data center 210. The remote communication device 215, for example, can include a computer, a smart phone, or other communication device. In certain embodiments, the remote communication device 215 can communicate with the data center 210 over the internet or over a cellular wireless network. The user can accordingly access the information stored in the data center 210 and operate the alarm system 100 away from the job site.

The alarm system 100 can be operated in various ways. The wireless signal 130 including the location signal 125 can be sent using the wireless communication module 110. One of the wireless signal 130 and a retransmission 135 of the wireless signal 130 can be received using the remote module 120. One of the wireless communication module 110 and the remote module 120 can be configured to trigger the alarm when the location signal 125 does not match the parameter, the alarm instructing the remote module to contact the emergency service 140 dependent on the location signal. The location signal 125 can be compared with the parameter and the alarm can be triggered when the location signal 125 does not match the parameter. The parameter can include one of GPS coordinates and an area defined by GPS coordinates. Where the alarm system 100 further comprises the alarm indicator module 170, the alarm indicator module 170 can be activated when the location signal 125 does not match the parameter. Where the wireless communication module 110 is configured to receive a wireless signal and the remote module 120 is configured to send one of a wireless signal and a signal that is retransmitted into a wireless signal, the remote module 120 can send an instruction to the wireless communication module 110. The instruction can include arming the alarm system 100, disarming the alarm system 100, providing a password, providing a password change, activating an alarm indicator module 170, deactivating an alarm indicator module 170, and combinations thereof.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An alarm system comprising:
a global positioning system (GPS) module, the GPS module configured to provide a location signal using GPS satellite signals;
a wireless communication module, the wireless communication module configured to send a wireless signal, the wireless signal including the location signal;
an independent power module, the independent power module configured to provide electrical power to the GPS module and the wireless communication module; and
a remote module, the remote module configured to receive one of the wireless signal and a retransmission of the wireless signal, the remote module configured to contact an emergency service dependent on the location signal.

2. The alarm system of claim 1, wherein the wireless communication module is configured to communicate with a cellular network.

3. The alarm system of claim 1, wherein the wireless communication module is configured to receive a wireless signal and the remote module is configured to send one of a wireless signal and a signal that is retransmitted into a wireless signal.

4. The alarm system of claim 1, wherein the independent power module includes a battery.

5. The alarm system of claim 1, wherein the independent power module is configured to generate electrical power using a member selected from the group consisting of a solar panel, a wind turbine, a hydroelectric generator, an internal combustion engine, and combinations thereof.

6. The alarm system of claim 1, wherein the independent power module includes a battery and is configured to generate electrical power using a solar panel.

7. The alarm system of claim 1, wherein the remote module is configured to record information contained in the one of the wireless signal and the retransmission of the wireless signal.

8. The alarm system of claim 1, wherein one of the wireless communication module and the remote module is configured to trigger an alarm when the location signal does not match a parameter, the alarm instructing the remote module to contact the emergency service dependent on the location signal.

9. The alarm system of claim 8, wherein the parameter includes one of GPS coordinates and an area defined by GPS coordinates.

10. The alarm system of claim 3, wherein the remote module is configured to send an instruction to the wireless communication module, the instruction including a member selected from the group consisting of arming, disarming, a password, a password change, alarm activation, alarm deactivation, and combinations thereof.

11. The alarm system of claim 1, wherein the emergency service dependent on the location signal includes a member selected from the group consisting of law enforcement, private security, a fire department, a medical service, and combinations thereof.

12. The alarm system of claim 1, further comprising an interface module, the interface module configured to receive an input and provide an output of the alarm system.

13. The alarm system of claim 1, further comprising an alarm indicator module, the alarm indicator module including a member selected from the group consisting of a siren, a light, a strobe, and combinations thereof.

14. The alarm system of claim 1, further comprising at least one sensor module in communication with the wireless communication module, the wireless signal including a signal from the sensor module, the sensor module including a member selected from the group consisting of a motion sensor, a door contact, a window contact, a sound sensor, a temperature sensor, a smoke detector, and combinations thereof.

15. The alarm system of claim 1, wherein the GPS module, the wireless communication module, and the independent power module are contained in one or more weather resistant and shock resistant enclosures.

16. A method of operating an alarm system comprising:
providing an alarm system including:
a global positioning system (GPS) module, the GPS module configured to provide a location signal using GPS satellite signals;
a wireless communication module, the wireless communication module configured to send a wireless signal, the wireless signal including the location signal;
an independent power module, the independent power module configured to provide electrical power to the GPS module and the wireless communication module; and
a remote module, the remote module configured to receive one of the wireless signal and a retransmission of the wireless signal, the remote module configured to contact an emergency service dependent on the location signal;
sending the wireless signal using the wireless communication module;
receiving one of the wireless signal and a retransmission of the wireless signal using the remote module.

17. The method of claim 16, wherein one of the wireless communication module and the remote module is configured to trigger an alarm when the location signal does not match a parameter, the alarm instructing the remote module to contact the emergency service dependent on the location signal, the method further comprising:
comparing the location signal with the parameter and triggering the alarm when the location signal does not match the parameter.

18. The method of claim 17, wherein the parameter includes one of GPS coordinates and an area defined by GPS coordinates.

19. The method of claim 17, wherein the alarm system further comprises an alarm indicator module, the alarm indicator module including a member selected from the group consisting of a siren, a light, a strobe, and combinations thereof, and the method further comprises:
activating the alarm indicator module when the location signal does not match the parameter.

20. The method of claim 16, wherein the wireless communication module is configured to receive a wireless signal and the remote module is configured to send one of a wireless signal and a signal that is retransmitted into a wireless signal, the remote module is configured to send an instruction to the wireless communication module, the instruction including a member selected from the group consisting of arming the alarm system, disarming the alarm system, providing a password, providing a password change, activating an alarm indicator module, deactivating an alarm indicator module, and combinations thereof, and the method further comprises:
sending the instruction to the wireless communication module.
